(19) United States
(12) Patent Application Publication
(10) Pub. No.: US 2023/0348170 A1
(43) Pub. Date: Nov. 2, 2023

(54) Multi-Use Plastic Bag

(71) Applicant: Green IP, LLC, Green Cove Springs, FL (US)

(72) Inventors: Robert Neal Alfred Hawkinson, Orange Park, FL (US); Kelvin T. Okamoto, Carmel, IN (US)

(21) Appl. No.: 18/307,513

(22) Filed: Apr. 26, 2023

Related U.S. Application Data
(60) Provisional application No. 63/335,280, filed on Apr. 27, 2022.

(51) Int. Cl. B65D 81/36; B65D 33/06

(52) U.S. Cl. CPC B65D 81/36; B65D 33/065

(57) ABSTRACT

This invention relates to a bag, such as t-shirt, merchandise, dry cleaning, vegetable, grocery, carry and food bags, and more particularly relates to a bag that can be converted into another use.

### CROSS REFERENCE TO RELATED PATENT APPLICATIONS

This invention claims priority from U.S. Provisional Patent Application No. 63/335,280, filed Apr. 27, 2022, which is hereby incorporated by reference.

### FIELD OF THE INVENTION

This invention relates to a bag, such as t-shirt, merchandise, dry cleaning, vegetable, grocery, carry, and food bags, and more particularly relates to a bag that can be converted into another use.

### BACKGROUND OF THE INVENTION

Conventional plastic bags are of many types and uses. Bags can be used to carry merchandise, such as food or household items after purchase, to package items from manufacturer to store to consumer, such as for wrapped clothing, or to package items in a store, such as fruits and vegetables. The bags have many different names, e.g., t-shirt, merchandise, dry cleaning, vegetable, grocery, carry, and food bags.

Such conventional plastic bags, however, are generally not curbside recyclable because of restrictions imposed by refuse collection services that require the customer to take such plastic bags to a closed loop recycling bin, specifically for recycling plastic film and bags. These bins are often located at grocery stores and big box stores. Consequently, many conventional plastic bags end up in a landfill or disposed of as litter. Moreover, conventional plastic bags are not biodegradable and will remain in a landfill or other environment for extended periods of time.

### SUMMARY OF THE INVENTION

To improve the environmental footprint of open top plastic bags, this invention allows the reuse of the plastic bags in in secondary applications such as a table protector for craft projects or as a soil biodegradable weed block. To further improve the environmental footprint of the plastic bags, the bags can be made from biodegradable materials and further incorporate additional functionality as also possible with the non-biodegradable bags.

The non-biodegradable bags can be produced from any plastic material including polyethylene (PE) such as low density, medium density, linear low density, and high density PE, polypropylene (PP) including homopolymer, random copolymer and heterophasic copolymer PP, and blends of any of the materials.

The material for the biodegradable bags can be produced from any biodegradable material, including those that are industrial or backyard (home) compostable, soil biodegradable, water biodegradable, or anaerobically biodegradable. Such plastics include polylactic acid (PLA), polyhydroxyalkanoate (PHA), polybutylene succinate (PBS), polybutylene adipate terephthalate (PBAT), thermoplastic starch (TPS), cellulose acetate (CA), polybutylene adipate succinate (PBAS), and blends thereof. One specific biodegradable plastic formulation is a biodegradable aliphatic polyester produced primarily from diacid and diol monomers and described in detail in U.S. Patent Publication No. 2019/0375932, published Dec. 12, 2019 (now U.S. Pat. No. 11,608,436), which is incorporated herein by reference in its entirety. The inventive biodegradable plastic formulation is 90% biodegradable in soil in about 90 days or 90% biodegradable in water in about 451 days.

The secondary use of the plastic bag can be encouraged through printing or cut lines or through perforations and tear lines to allow easy reconfiguration of the bag into another use. Such uses include a tabletop protector for craft projects, a drop cloth for furniture or floor protection, weed block for preventing weed growth in the garden, or a moisture retention film to keep water from draining into sand and thereby to help keep plants watered in low rainfall locations. Furthermore, perforations or printed cut lines may also exist for indicating locations or separations for holes to plant plants through the bag when used as a moisture barrier or weed block. The bag of the present invention has a front panel and a back panel. The front panel and back panel are joined at their side edges and bottom edge to form the bag with a top opening. Optionally, handles exist by extending from the top of the front panel and back panel or as cut outs in front and back panel.

In one embodiment, the bag of the present invention is constructed with microperforations that extend along the side edges of the bag and along the top edges of the handles. By breaking the bag at the microperforations along the sides of the bag and along the top edges of the handles, the bag unfolds along the bottom edge to create a flat sheet that can be used as cover for a craft table or drop cloth, or if soil or water biodegradable, as a weed block or moisture barrier. Alternatively, the microperforations can extend along one side edge, along the bottom edge, and along the top edges of the handles to create a flat sheet.

The bag of the present invention may additionally have tear perforations for enabling easy removal of some of the bag. The tear perforations may outline a circle, concentric circles, squares, an X or any other shape. After material is removed along the tear perforations, plants may be planted through a biodegradable bag using the newly created hole(s).

In order to use the weed suppression sheet created by breaking open the bag along the microperforations, the weed suppression sheet is laid on top of the underlying soil of a planting bed. The user can then punch or tear out holes in the weed suppression sheet to accommodate plants. Once planting is complete, additional soil or mulch can be laid on top of the bag. The weed suppression sheet controls weeds as the plants established themselves, and after a short few months depending upon film thickness and film material formulation, the weed suppression sheet will have basically disappeared so that future digging in the planting bed will not be hindered by the weed suppression sheet.

Further objects, features and advantages will become apparent upon consideration of the following detailed description of the invention when taken in conjunction with the drawings and the appended claims.

### BRIEF DESCRIPTION OF THE DRAWINGS

FIG. 1 is a front elevation view of a bag in accordance with the present invention.

FIG. 2 is a back elevation view of the bag in accordance with the present invention.

FIG. 3 is a section view of the bag as seen along line 3-3 of FIG. 1 in accordance with the present invention.

FIG. 4 is a top plan view of the sheet created by breaking open the bag along microperforations on the sides and the handles in accordance with the present invention.

FIG. 5 is a front elevation view of the sheet created by breaking open the bag along microperforations on the bottom edge, one side edge, and the handles in accordance with the present invention.

### DETAILED DESCRIPTION OF THE PREFERRED EMBODIMENT

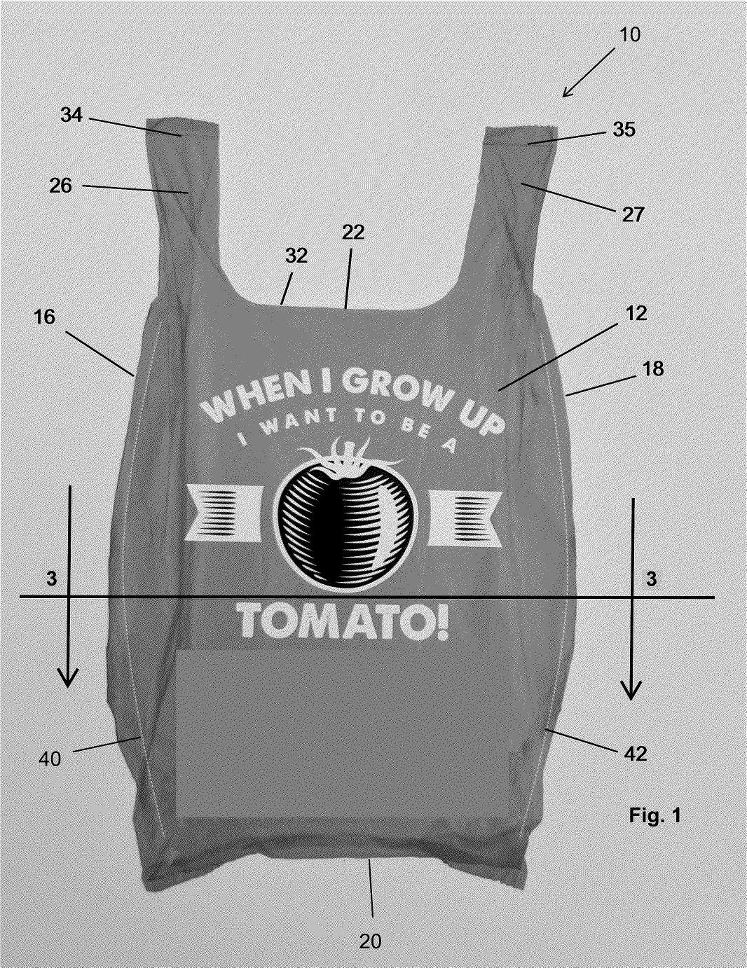

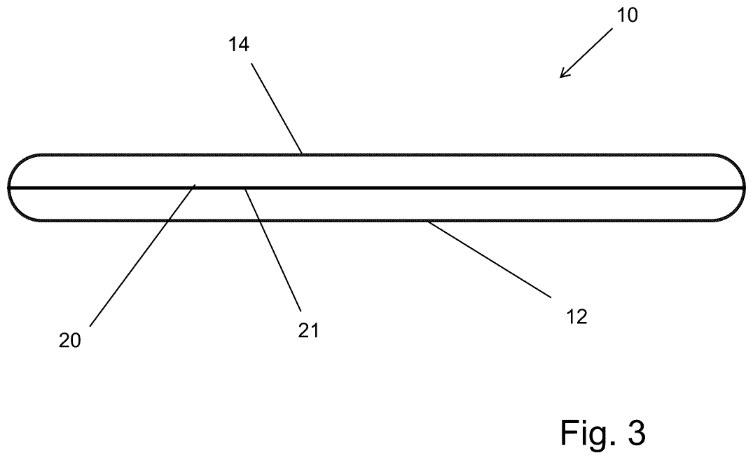

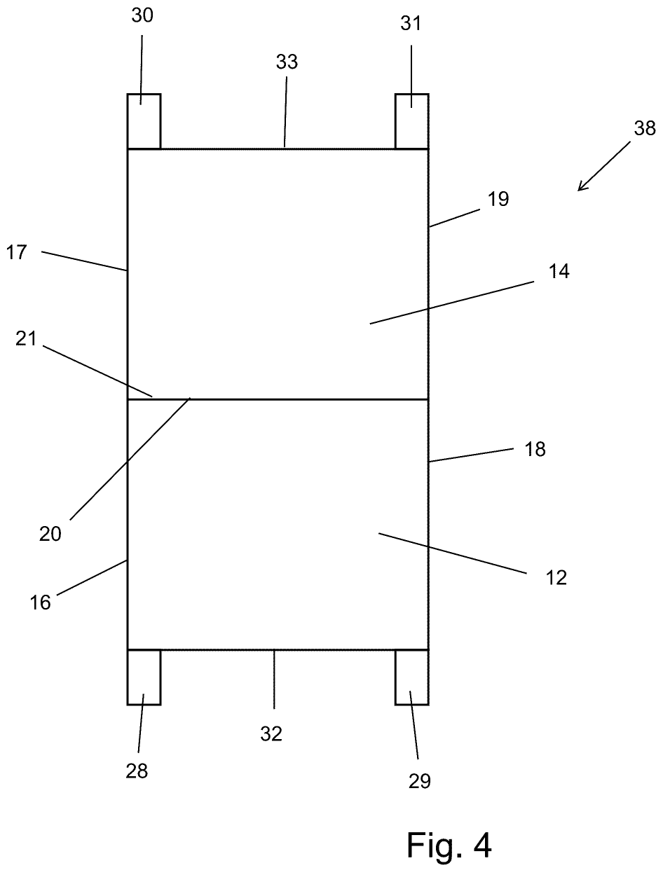

With reference to FIGS. 1-5, an open top bag 10 of the present invention has a front panel 12 and a back panel 14. The front panel 12 and back panel 14 are joined along the left front side edge 16 and the left back side edge 17, along the right front side edge 18 and right back side edge 19, and along the front bottom edges 20 and the back bottom edge 21 to form the bag 10 with a top opening 22. Left handle 26 and right handle 27 are positioned on either side of the top opening 22. The left handle 26 is formed by left front handle portion 28 and left back handle portion 30. The right handle 27 is formed by right front handle portion 29 and right back handle portion 31 (FIG. 4). The handle portions 28 and 30 and handle portions 29 and 31 are joined at their top edges to form left handle 26 and right handle 27 respectively. Thus formed, the handles 26 and 27 allow the user to carry the bag 10 containing purchased items.

The non-biodegradable bags can be produced from any plastic material including polyethylene (PE) such as low density, medium density, linear low density and high density PE, polypropylene (PP), including homopolymer, random copolymer and heterophasic copolymer PP, and blends of any of the materials.

For a biodegradable bag 10 and resulting weed suppression sheet 38, the formulation of the material is a biodegradable aliphatic polyester produced primarily from diacid and diol monomers, described in detail in U.S. Patent Publication No. 2019/0375932, published Dec. 12, 2019, (now U.S. Pat. No. 11,608,436), which is incorporated herein by reference in its entirety.

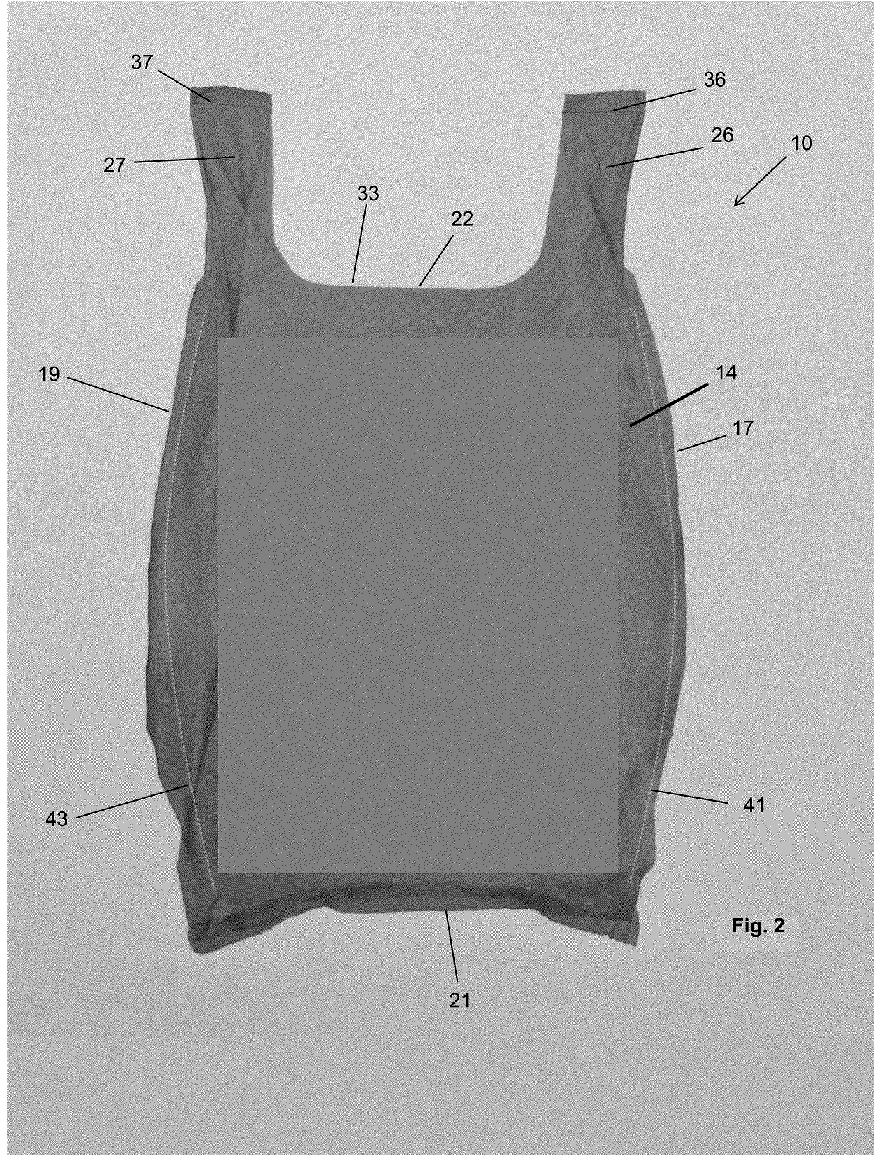

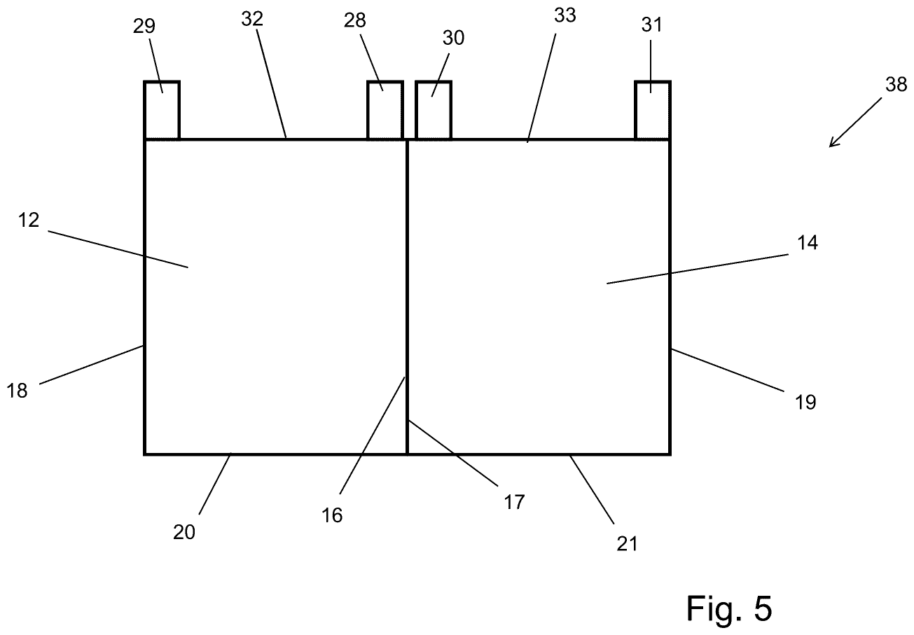

The biodegradable bag 10 can be broken down into a flat sheet to create a weed suppression sheet 38 (FIG. 4 and FIG. 5). In order to create the weed suppression sheet 38 of FIG. 4, the front panel 12 has left front side microperforations 40 extend along the left front side edge 16 and right front side microperforations 42 extending along the right front side edge 18 (FIG. 1). In addition, the back panel 14 has left back side microperforations 41 extend along the left back side edge 17, right back side microperforations 43 extending along the right back side edge 19 (FIG. 2).

The left handle 26 has left front handle microperforations 34 and left back handle microperforations 36 extending along the top edges of the handle 26. The right handle 27 has right front handle microperforations 35 and right back handle microperforations 37 extend along the top edges of handle 27.

In order to create the weed suppression sheet 38 of FIG. 5, the front panel 12 has left front side microperforations 40 extend along the left front side edge 16 and bottom front side microperforations extending along the front bottom edge 20. Likewise, the back panel 14 has left back side microperforations 41 extend along the left back side edge 17 and bottom back side microperforations extending along the back bottom edge 21.

By breaking the microperforations shown in FIG. 1, the bag 10 unfolds along the bottom edges 20 and 21 to create the flat biodegradable weed suppression sheet 38 of FIG. 4. Alternatively, by breaking the bag 10 at the microperforations along the one side edge, along the bottom edge, and along the top edges of the handles, the bag 10 unfolds along the opposite side edge to create a flat biodegradable weed suppression sheet 38 (FIG. 5).

In order to use the weed suppression sheet 38 created by breaking open the bag along the microperforations (FIG. 4 or FIG. 5), the weed suppression sheet 38 is laid on top of the underlying soil of a planting bed. The user can then punch or tear holes in the weed suppression sheet 38 to accommodate plants. Once the planting is complete, additional soil or mulch can be laid on top of the weed suppression sheet 38. The weed suppression sheet 38 controls weeds as the plants established themselves, and after about 90 days, the weed suppression sheet will have basically disappeared so that future digging in the planting bed will not be hindered by the weed suppression sheet 38.

While this invention has been described with reference to preferred embodiments thereof, it is to be understood that variations and modifications can be affected within the spirit and scope of the invention as described herein and as described in the appended claims.

I claim:

1. An open top bag comprising:
a. a front panel
b. a back panel, the back panel connected to the front panel along side edges and a bottom edge to create the bag with a top opening; and wherein
c. the bag is printed or perforated to provide means for converting the bag for other uses.

2. A bag of claim 1 wherein
handles are connected to the front panel and the back panel adjacent to the top opening.

3. A bag of claim 1 wherein
the material of the bag is a biodegradable aliphatic polyesters produced primarily from diacid and diol monomers.

4. A bag of claim 1 wherein
the other uses comprise of a cover for table protection, drop cloth, weed block and moisture barrier.

5. A bag of claim 1 wherein printed lines or perforations provide guides for removing film.

6. The convertible open top bag comprising:
a. a front panel;
b. a back panel, the back panel connected to the front panel along side edges and a bottom edge to create the biodegradable bag with an top opening; and
c. handles connected to the front panel and the back panel adjacent the top opening,
wherein the side edges include perforations and the handles include perforations so that the convertible bag can be broken down to create a flat sheet.
